(19) United States
(12) Patent Application Publication
(10) Pub. No.: US 2007/0264479 A1
(43) Pub. Date: Nov. 15, 2007

(54) AESTHETIC TRANSPARENCY

(76) Inventors: James P. Thiel, Pittsburgh, PA (US); John A. Winter, Pittsburgh, PA (US); Cheryl E. Belli, New Kensington, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/745,034

(22) Filed: May 7, 2007

Related U.S. Application Data
(60) Provisional application No. 60/798,828, filed on May 9, 2006.
(60) Provisional application No. 60/855,219, filed on Oct. 30, 2006.

(51) Int. Cl. G03G 7/00

(52) U.S. Cl. 428/195.1

(57) ABSTRACT

A laminated transparency includes a first ply having a No. 1 and a No. 2 surface, a second ply having a No. 3 and a No. 4 surface, and an interlayer positioned between the first and second plies. An aesthetic coating is deposited over at least a portion of the first or second plies. The transparency has a color defined by |a*|≧10 and |b*|≧10 and, in one non-limiting embodiment, L*≧40.

### CROSS-REFERENCE TO RELATED APPLICATION

This application claims priority to U.S. Provisional Application Ser. No. 60/798,828 filed May 9, 2006 and U.S. Provisional Application Ser. No. 60/855,219 filed Oct. 30, 2006, both of which applications are herein incorporated by reference in their entirety.

### BACKGROUND OF THE INVENTION

1. Field of the Invention

This invention relates generally to transparencies, such as but not limited to vehicle windshields, side lights, back lights, and the like, and, in one particular embodiment, to a laminated vehicle transparency having a desirable aesthetic appearance.

2. Technical Considerations

In today's automotive market, a heavy emphasis is placed on automotive styling. The way a vehicle looks can be as important to vehicle sales as the vehicle's mechanical reliability or safety rating. Therefore, automotive manufacturers have gone to great lengths to enhance vehicle styling. These styling enhancements include providing more vehicle color selections to the consumer and also providing colors having metallic flakes to provide the vehicle with a “polychromatic effect”.

While these styling enhancements have been generally well received by consumers, a problem to date is that even with the new vehicle paint finishes, the automotive transparencies (such as but not limited to windshields, side lights, back lights, moon roofs, and sunroofs) continue to be generally green, gray or neutral colored. It would be desirable to provide a vehicle transparency having a color that would complement the color of the vehicle body to provide an improved overall aesthetic appearance for the vehicle.

However, considerations other than color must be addressed in trying to incorporate more color into an automotive transparency. For example, in the United States, government regulations require that all passenger vehicle windshields must have a luminous (visible) light transmittance (Lta) of at least 70%. In Europe, the required minimum Lta is 75%. Any colored windshield would have to meet these standards.

Additionally, conventional vehicle windshields typically provide a solar control function to cut down on the amount of heat entering the vehicle through the windshield. It would be desirable to provide a colored windshield that includes a solar control function.

Therefore, it would be advantageous to provide an aesthetic transparency that provides the opportunity to coordinate the color of the transparency with the color of the vehicle body. It would further be advantageous if such a transparency also provided some solar control properties.

### SUMMARY OF THE INVENTION

A laminated transparency comprises a first ply having a No. 1 and a No. 2 surface, a second ply having a No. 3 and a No. 4 surface, and an interlayer positioned between the first and second plies. An aesthetic coating is formed over at least a portion of the first or second plies. The transparency has a color defined by at least one of |a*| and |b*| is greater than or equal to 10. In one non-limiting embodiment, L*≧40. In a further non-limiting embodiment, C* can have a range of 15≦C*≦90 and L*≧40.

Another laminated transparency comprises a first glass ply having a No. 1 and a No. 2 surface, a second glass ply having a No. 3 and a No. 4 surface, and an interlayer positioned between the first and second glass plies. The transparency further includes an aesthetic coating deposited over at least a portion of the No. 2 surface of the first ply. The aesthetic coating comprises a coating stack comprising a layer structure: H¹/m¹/H²/m²/H³, where H¹, H² and H³ represent layers comprising at least one high refractive index material (a material having a refractive index greater than 1.75) and M¹ and M² represent metallic layers. The transparency has a color defined by at least one of |a*|≧10 and |b*|≧10. In one non-limiting embodiment, L*≧40. In a further non-limiting embodiment, C* can have a range of 15≦C*≦90 and L*≧40 Å reflective coating, such as an antireflective coating, can be formed over at least a portion of the second glass ply, such as on the No. 4 surface of the second ply.

Another laminated transparency comprises a first glass ply having a No. 1 and No. 2 surface, a second glass ply having a No. 2 and a No. 3 surface, and a polymeric interlayer positioned between the first and second glass plies. An aesthetic coating is formed over at least a portion of the No. 2 surface. The aesthetic coating comprises a coating stack comprising a layer structure: H/M/H/M/H, where H comprises zinc stannate and M comprises silver. The transparency has a color defined by at least one of |a*| and |b*|≧10. In one non-limiting embodiment, L*≧40. In a further non-limiting embodiment, C* can have a range of 15≦C*≦90 and L*≧40. A protective overcoat can be deposited over the aesthetic coating. The protective coating can comprise a multi-layer coating stack comprising at least one of silica, alumina, zirconia, and mixtures or combinations thereof. A reflection coating, such as an antireflective coating, can be formed over at least a portion of the No. 4 surface. The antireflective coating can comprise a first layer having a refractive index greater than 1.75, a second layer deposited over the first layer and having a refractive index less than or equal to 1.75, a third layer deposited over the second layer and having a refractive index greater than 1.75, and a fourth layer deposited over the third layer and having a refractive index less than or equal to 1.75.

A further laminated transparency comprises a first ply, a second ply, an interlayer positioned between the first and second plies, and an aesthetic coating positioned between the first and second plies. The transparency has a color defined by at least one of |a*| and |b*| is ≧10 and L*≧40.

### BRIEF DESCRIPTION OF THE DRAWINGS

The invention will be described with reference to the following drawing figures, wherein like reference numbers identify like parts throughout.

FIG. 1 is a side, sectional view (not to scale) of a laminated vehicle windshield incorporating features of the invention;

FIG. 2 is a side, sectional view (not to scale) of a first exemplary aesthetic coating of the invention;

FIG. 3 is a side, sectional view (not to scale) of a second exemplary aesthetic coating of the invention;

FIG. 4 is a side, sectional view (not to scale) of a third exemplary aesthetic coating of the invention;

FIG. 5 is a side, sectional view (not to scale) of an antireflective coating of the invention;

FIG. 6 is a graph of a* and b* values for one non-limiting embodiment of a coated article of the invention; and

FIG. 7 is a graph of a* and b* values for another non-limiting embodiment of a coated article of the invention.

### DESCRIPTION OF THE PREFERRED EMBODIMENTS

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and statements are to be understood as being modified in all instances by the term “about”. Accordingly, unless indicated to the contrary, the numerical values set forth in the following specification and statements may vary depending upon the desired properties sought to be obtained by the present invention. At the very least, and not as an attempt to limit the application of the doctrine of equivalents to the scope of the statements, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. As used herein, the terms “polymer” or “polymeric” include oligomers, homopolymers, copolymers, and terpolymers, e.g., polymers formed from two or more types of monomers or polymers. The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm. Additionally, all documents, such as but not limited to issued patents and patent applications, referred to herein are to be considered to be “incorporated by reference” in their entirety. The term “aesthetic coating” refers to a coating provided to enhance the aesthetic properties of the substrate, e.g., color, shade, hue, or visible light reflectance, but not necessarily the solar control properties of the substrate. However, the aesthetic coating could also provide properties other than aesthetics, such as, for example, ultraviolet (UV) radiation absorption or reflection and/or infrared (IR) absorption or reflection. The aesthetic coating could also provide some solar control effect simply by lowering the visible light transmittance through the article. In the following discussion, the refractive index values are those for a reference wavelength of 550 nanometers (nm). The term “film” refers to a region of a coating having a desired or selected composition. A “layer” comprises one or more “films”. A “coating” or “coating stack” is comprised of one or more “layers”. The absolute value of a number “N” is written herein as |N|. By “absolute value” is meant the numerical value of a real number with out regard to its sign. All quarter wave optical thicknesses values herein are defined relative to a reference wavelength of 550 nm.

For purposes of the following discussion, the invention will be described with reference to use with a vehicle transparency, in particular a laminated automotive windshield. However, it is to be understood that the invention is not limited to use with vehicle windshields but could be practiced in any desired field, such as but not limited to laminated or non-laminated residential and/or commercial windows, insulating glass units, and/or transparencies for land, air, space, above water and under water vehicles, e.g., automotive windshields, sidelights, back lights, sunroofs, and moon roofs, just to name a few. Therefore, it is to be understood that the specifically disclosed exemplary embodiments are presented simply to explain the general concepts of the invention and that the invention is not limited to these specific exemplary embodiments. Additionally, while a typical vehicle “transparency” can have sufficient visible light transmittance such that materials can be viewed through the transparency, in the practice of the invention, the “transparency” need not be transparent to visible light but may be translucent or opaque (as described below). The aesthetic coating of the invention can be utilized in making laminated or non-laminated, e.g., single ply or monolithic, articles. By “monolithic” is meant having a single structural substrate or primary ply, e.g., a glass ply. By “primary ply” is meant a primary support or structural member. In the following discussion, the exemplary article (whether laminated or monolithic) is described as an automotive windshield.

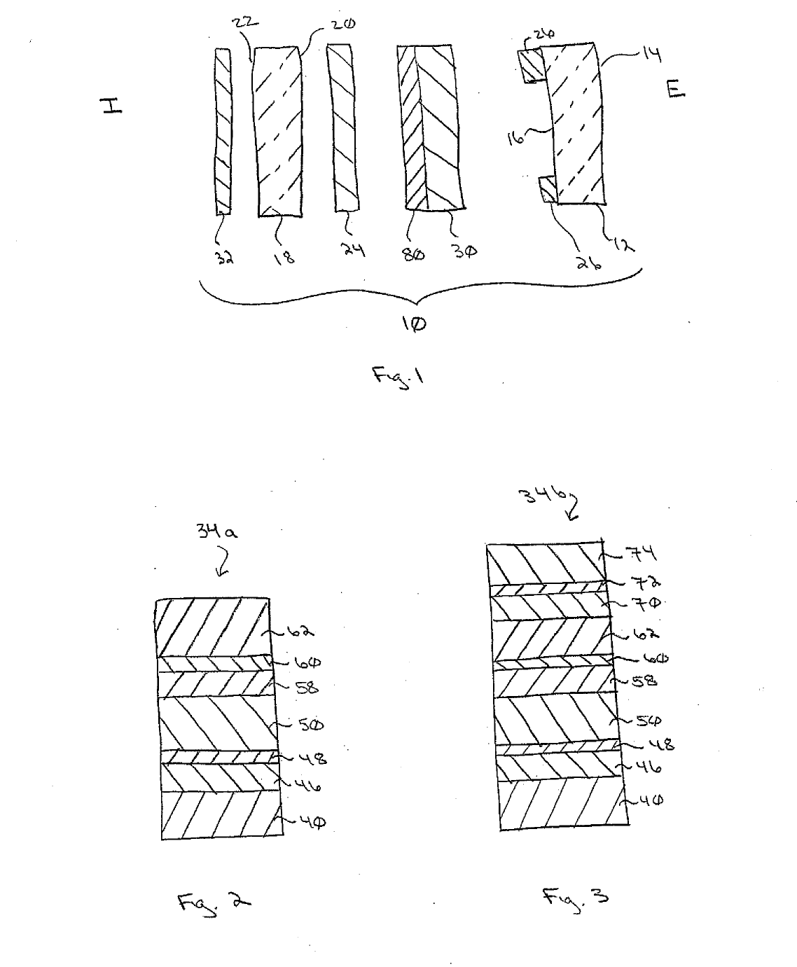

A non-limiting transparency 10 (e.g., automotive windshield) incorporating features of the invention is illustrated in FIG. 1. The transparency 10 can have any desired visible light, infrared radiation, or ultraviolet radiation transmission and reflection. For example, the transparency 10 can have a visible light transmission of any desired amount, e.g., greater than 0% up to 100%, e.g., greater than 70%. For windshield and front sidelight areas in the United States, the visible light transmission is typically greater than or equal to 70%. For privacy areas, such as rear seat sidelights and rear windows, the visible light transmission can be less than that for windshields, such as less than 70%.

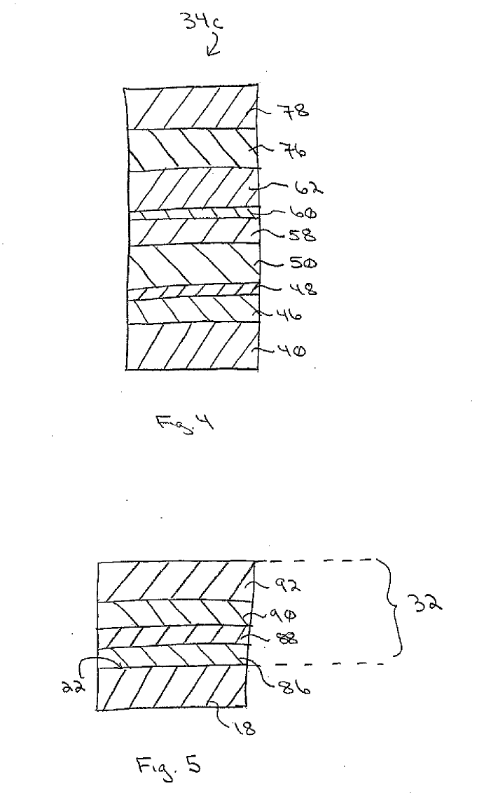

The transparency 10 includes a first ply 12 with a first major surface and a second major surface. In the illustrated example, the first major surface faces the vehicle exterior “E”, i.e., is an outer major surface 14 (No. 1 surface), and the opposed second or inner major surface 16 (No. 2 surface) faces the interior “I” of the vehicle. The transparency 10 also includes a second ply 18 having an outer (first) major surface 20 (No. 3 surface) facing the vehicle exterior E and an inner (second) major surface 22 (No. 4 surface). This numbering of the ply surfaces is in keeping with conventional practice in the automotive art. The first and second plies 12, 18 can be bonded together in any suitable manner, such as by a conventional interlayer 24. Although not required, a conventional edge sealant can be applied to the perimeter of the laminated transparency 10 during and/or after lamination in any desired manner. A decorative band, e.g., an opaque, translucent or colored band 26 (shown in FIG. 2), such as a ceramic band, can be provided on a surface of at least one of the plies 12, 18, for example around the perimeter of the inner major surface 16 of the first ply 12. An aesthetic coating 30 is formed over at least a portion of one of the plies 12, 18, such as over at least a portion of the No. 2 surface 16 or No. 3 surface 20. A reflection coating 32 can be formed over at least one of the surfaces, such as over at least a portion of the No. 4 surface 22. By “reflection coating” is meant a coating that impacts upon the visible light reflectance of the transparency 10. For example, the reflection coating can be an antireflective coating configured to decrease the visible light reflectance of the transparency 10 or a reflective coating configured to increase the visible light reflectance of the transparency.

In the broad practice of the invention, the plies 12, 18 of the transparency 10 can be of the same or different materials. The plies 12, 18 can include any desired material having any desired characteristics. For example, one or more of the plies 12, 18 can be transparent or translucent to visible light. By “transparent” is meant having visible light transmittance of greater than 0% to 100%. Alternatively, one or more of the plies 12, 18 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethyl methacrylates, polyethyl methacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, one or more of the plies 12, 18 can include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155. The first and second plies 12, 18 can each be, for example, clear float glass or can be tinted or colored glass or one ply 12, 18 can be clear glass and the other ply 12, 18 colored glass. Although not limiting to the invention, examples of glass suitable for the first ply 12 and/or second ply 18 are described in U.S. Pat. Nos. 4,746,347; 4,792,536; 5,030,593; 5,030,594; 5,240,886; 5,385,872; and 5,393,593. The first and second plies 12, 18 can be of any desired dimensions, e.g., length, width, shape, or thickness. In one exemplary automotive transparency, the first and second plies can each be 1 mm to 10 mm thick, e.g., 1 mm to 5 mm thick, or 1.5 mm to 2.5 mm, or 1.8 mm to 2.3 mm.

The interlayer 24 can be of any desired material and can include one or more layers. The interlayer 24 can be a polymeric or plastic material, such as, for example, polyvinylbutyral, plasticized polyvinyl chloride, or multi-layered thermoplastic materials including polyethyleneterephthalate, etc. Suitable interlayer materials are disclosed, for example but not to be considered as limiting, in U.S. Pat. Nos. 4,287,107 and 3,762,988. The interlayer 24 secures the first and second plies 12, 18 together, can provide energy absorption, can reduce noise, and can increase the strength of the laminated structure. The interlayer 24 can also be a sound-absorbing or attenuating material as described, for example, in U.S. Pat. No. 5,796,055. The interlayer 24 can have a solar control coating provided thereon or incorporated therein or can include a colored material to reduce solar energy transmission.

The aesthetic coating 30 provides the article 10 with aesthetic characteristics. As will be appreciated by one skilled in the art, the color of an object is highly subjective. Observed color will depend on the lighting conditions and the preferences of the observer. In order to evaluate color on a quantitative basis, several color order systems have been developed. One such method of specifying color adopted by the International Commission on Illumination (CIE) uses dominant wavelength (DW) and excitation purity (Pe). The numerical values of these two specifications for a given color can be determined by calculating the color coordinates x and y from the so-called tristimulus values X, Y, Z of that color. The color coordinates are then plotted on a 1931 CIE chromaticity diagram and numerically compared with the coordinates of CIE standard illuminant C, as identified in CIE publication No. 15.2. This comparison provides a color space position on the diagram to ascertain the excitation purity and dominant wavelength of the glass color.

In another color order system, the color is specified in terms of hue and lightness. This system is commonly referred to as the CIELAB color system. Hue distinguishes colors such as red, yellow, green and blue. Lightness, or value, distinguishes the degree of lightness or darkness. The numerical values of these characteristics, which are identified as L*, a* and b*, are calculated from the tristimulus values (X, Y, Z). L* indicates the lightness or darkness of the color and represents the lightness plane on which the color resides, a* indicates the position of the color on a red (+a*) green (−a*) axis, and b* indicates the color position on a yellow (+b*) blue (−b*) axis. When the rectangular coordinates of the CIELAB system are converted into cylindrical polar coordinates, the resulting color system is known as the CIELCH color system which specifies color in terms of lightness (L*), and hue angle (H°) and chroma (C*). L* indicates the lightness or darkness of the color as in the CIELAB system. Chroma, or saturation or intensity, distinguishes color intensity or clarity (i.e. vividness vs. dullness) and is the vector distance from the center of the color space to the measured color. The lower the chroma of the color, i.e. the less its intensity, the closer the color is to being a so-called neutral color. With respect to the CIELAB system, C*=(a*²+b*²)^{1/2}. Hue angle distinguishes colors such as red, yellow, green and blue and is a measure of the angle of the vector extending from the a*, b* coordinates through the center of the CIELCH color space measured counterclockwise from the red (+a*) axis.

It should be appreciated that color may be characterized in any of these color systems and one skilled in the art may calculate equivalent DW and Pe values; L*, a*, b* values; and L*, C*, H° values from the transmittance curves of the viewed glass or composite transparency. A detailed discussion of color calculations is given in U.S. Pat. No. 5,792,559. In the present document, color is characterized using the CIELAB system (L* a* b*). However, it is to be understood that this is simply for ease of discussion and the disclosed colors could be defined by any conventional system, such as those described above.

In one non-limiting embodiment of the invention, the aesthetic coating 30 may not impact or may impact only slightly the solar control properties of the coated article 10. In one non-limiting embodiment, the aesthetic coating 30 can provide the transparency 10 with a reflected color within the color space defined by −40≦a*≦50, such as −40≦a*≦45, such as −40≦a*≦40, such as −30≦a*≦40, such as −20≦a*≦40, such as −20≦a*≦30. In another non-limiting embodiment, |a*| is greater than or equal to 10. That is, a* is greater than or equal to 10 units from the a* origin. For example, a* can be in the range of 10 to 50 in the positive region and in the range of −10 to −50 in the negative region, that is 10≦|a*|≦50, such as 20≦|a*|≦50, such as 30≦|a*|≦50, such as 40≦|a*|≦50.

In one non-limiting embodiment, the aesthetic coating 30 can provide a b* in the range of −75≦b*≦40, such as −60≦b*≦30, such as −50≦b*≦30, such as −40≦b*≦25, such as −30≦b*≦20, such as −20≦b*≦10, such as −10≦b*≦5. In another non-limiting embodiment, |b*| is greater than or equal to 10, that is greater than or equal to 10 units from the b* origin. For example, 0≦|b*|≦80, such as 20≦|b*|≦80, such as 30≦|b*|≦80, such as 40≦|b*|≦80, such as 50≦|b*|≦80, such as 60≦|b*|≦80, such as 70≦|b*|≦80|.

In one non-limiting embodiment, the transparency 10 has a color defined by 15≦C*≦90, such as 20≦C*≦90, such as 30≦C*≦90, such as 40≦C*≦90, such as 50≦C*≦90, such as 60≦C*≦90, such as 70≦C*≦90, such as 80≦C*≦90.

In another non-limiting embodiment, one of |a*| or |b*| has a value of greater than or equal to 10 while the other of |a*| or |b*| can have a value between 0 and 10.

The aesthetic coating can provide an L* in the range of 30≦L*≦60, such as 40≦L*≦60, such as 50≦L*≦60, such as L* greater than or equal to 40.

In the above non-limiting embodiment, the aesthetic coating 30 was formed over at least a portion of one of the plies 12, 18. However, it is to be understood that the aesthetic coating 30 need not be limited to this location. In another non-limiting embodiment, the aesthetic coating 30 could be formed on a plastic or polymeric film (such as PET), which film could be embedded in the interlayer 24.

In one non-limiting embodiment, the aesthetic coating 30 comprises one or more metallic layers and one or more layers of dielectric coating materials. In one non-limiting embodiment, the metallic layers can include at least one metal selected from the group consisting of gold, copper, silver, aluminum, or mixtures, alloys, or combinations thereof.

Exemplary dielectric materials for use in the present invention include, but are not limited to, silica, alumina, zinc oxide, tin oxide, niobium oxide, tantalum oxide, zirconia, titania, carbon (generally known to those in the art as “diamond like carbon” or DLC), and oxides, nitrides, or oxynitrides of one or more metals, such as silicon oxynitrides, zinc and tin materials (such as but not limited to zinc stannate), and silicon and aluminum materials, or any combinations containing any one or more of the above materials.

The aesthetic coating 30 can also include one or more additives or dopants to affect the properties of the aesthetic coating 30, such as refractive index, photocatalytic activity, and other like properties known to those skilled in the art. Examples of dopants include, but are not limited to, sodium, nickel, transition metals, and mixtures containing any one or more of the foregoing.

The aesthetic coating 30 can be of any thickness to achieve the desired color and reflectance values described above. As will be appreciated by one skilled in the art, the specific thickness of the aesthetic coating 30 can vary depending upon the selected material(s) in order to achieve the desired color and reflectivity. Additionally, the aesthetic coating 30 need not be of uniform thickness across the entire surface upon which it is deposited. For example, the aesthetic coating 30 can be of non-uniform or varying thickness (e.g., have higher and lower areas of thickness) to provide a perceived color difference over the coated surface, such as a rainbow effect.

For use in forward automotive transparencies (such as windshields and front sidelights), the transparency 10 can have an Lta of greater than or equal to 70%, such as greater than or equal to 72%, or greater than or equal to 75%. For non-forward vision panels (e.g., “privacy glass”) the Lta can be less than 75%, such as less than 70% or less than 65%.

In order to provide the transparency 10 (e.g. a laminated automotive transparency) with an aesthetically desirable shine or sparkle, the transparency 10 can have a visible light reflectance in the range of 8% to 50%, such as 8% to 30%, such as 8% to 25%, such as 8% to 20%, such as 15% to 25%, such as 16% to 20%, such as 9% to 19%. As will be appreciated by one skilled in the art, for laminated articles, the reflectance is typically defined with respect to the exterior reflectance of the laminated article. By “exterior reflectance” is meant the reflectance of the exterior surface (No. 1 surface) with the aesthetic coating 30 provided on an interior surface, such as the No. 2 or No. 3 surface.

The aesthetic coating 30 can be deposited by any conventional method, such as but not limited to conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as but not limited to sol-gel deposition. In one non-limiting embodiment, the conductive coating 30 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

Exemplary coating stacks 34a-34c that can be incorporated into the aesthetic coating 30 for the practice of the invention are shown in FIGS. 2-4.

The exemplary non-limiting coating stack 34a shown in FIG. 2 includes a base layer or first dielectric layer 40 deposited over at least a portion of a major surface of a substrate (e.g., the No. 2 surface 16 of the first ply 12)(ply 12 is not shown in FIG. 2). The first dielectric layer 40 can comprise one or more films of antireflective materials and/or dielectric materials, such as but not limited to metal oxides, oxides of metal alloys, nitrides, oxynitrides, or mixtures thereof. The first dielectric layer 40 can be transparent to visible light. In the practice of the invention, the first layer 40 comprises at least one high refractive index material. As used herein, the terms “low” and “high” with respect to refractive index can be relative terms with respect to the materials of the coating stack. For example, in a coating stack a “high” refractive index material can be any material having a refractive index greater than that of the “low” refractive index material (that is the material having the lowest relative refractive index value for the materials in the stack). In one non-limiting embodiment, a “low” refractive index material is a material having an index of refraction of less than or equal to 1.75 and a “high” refractive index material is a material having an index of refraction of greater than 1.75. Non-limiting examples of low refractive index materials include silica, alumina, and mixtures or combinations thereof. Non-limiting examples of high refractive index materials include zirconia, titania, zinc stannate, and zinc oxide. In one non-limiting embodiment, the first layer 40 comprises a zinc/tin alloy oxide. The zinc/tin alloy oxide can be that obtained from magnetron sputtering vacuum deposition from a cathode of zinc and tin that can comprise zinc and tin in proportions of 10 wt. % to 90 wt. % zinc and 90 wt. % to 10 wt. % tin. One suitable metal alloy oxide that can be used in the base layer 40 is zinc stannate. By “zinc stannate” is meant a composition of Zn_{X}Sn_{1-X}O_{2-X} (Formula I) where “x” varies in the range of greater than 0 to less than 1. For instance, “x” can be greater than 0 and can be any fraction or decimal between greater than 0 to less than 1. For example where x=2/3, Formula I is Zn_{2/3}Sn_{1/3}O_{4/3}, which is more commonly described as “Zn₂SnO₄”. A zinc stannate-containing film can have one or more of the forms of Formula I in a predominant amount in the film. In one non-limiting embodiment, the base layer 40 comprises zinc stannate and has a thickness in the range of 50 Å to 600 Å, e.g. 100 Å to 600 Å, or 150 Å to 500 Å, or 200 Å to 500 Å, or 300 Å to 500 Å, or 400 Å to 500 Å. Other materials that can be used as first dielectric layer 40 can have similar thickness ranges. In another non-limiting embodiment, the base layer can be a multi-layer structure. For example, the base layer 40 can include a zinc stannate layer as described above and another layer, such as a zinc oxide layer over the zinc stannate layer. The zinc oxide layer can have a thickness in the range of 10 Å to 600 Å, e.g. 20 Å to 500 Å, or 30 Å to 300 Å, or 50 Å to 300 Å, or 80 Å to 300 Å, or 100 Å to 200 Å.

A first heat and/or radiation reflective film or layer 46 can be deposited over the first dielectric layer 40. The first reflective layer 46 can include a reflective metal, such as but not limited to metallic gold, copper, silver, or mixtures, alloys, or combinations thereof. In one non-limiting embodiment, the first reflective layer 46 comprises a metallic silver layer having a thickness in the range of 25 Å to 300 Å, e.g., 30 Å to 300 Å, or 50 Å to 200 Å, or 70 Å to 200 Å, or 100 Å to 200 Å, or 90 Å to 170 Å, or 150 Å. Other materials that can be used as first reflective layer 46 can have similar thickness ranges.

A first primer film 48 can be deposited over the first reflective layer 46. The first primer film 48 can be an oxygen-capturing material, such as titanium, that can be sacrificial during the deposition process to prevent degradation or oxidation of the first reflective layer 46 during the sputtering process or subsequent heating processes. The oxygen-capturing material can be chosen to oxidize before the material of the first reflective layer 46. If titanium is used as the first primer film 48, the titanium would preferentially oxidize to titanium dioxide before oxidation of the underlying layer 46. In one non-limiting embodiment, the first primer film 48 is titanium having a thickness in the range of 5 Å to 50 Å, e.g., 10 Å to 40 Å, or 15 Å to 25 Å, or 20 Å. Other materials that can be used as primer film 48 can have similar thickness ranges.

A second dielectric layer 50 can be deposited over the first reflective layer 46 (e.g., over the first primer film 48). The second dielectric layer 50 can comprise one or more metal oxide or metal alloy oxide-containing films, such as those described above with respect to the first dielectric layer 40. In the illustrated non-limiting embodiment, the second dielectric layer 50 comprises at least one high refractive index material, such as but not limited to zinc stannate (Zn_{0.95}Sn_{0.05}O_{1.05}), and has a thickness in the range of 100 Å to 1500 Å, e.g., 200 Å to 1500 Å, or 400 Å to 1500 Å, or 500 Å to 1500 Å, or 600 Å to 1000 Å. Other materials that can be used as second dielectric layer 50 can have similar thickness ranges. In another non-limiting embodiment, the second dielectric layer 50 can be a multi-layer structure. For example, the second dielectric layer 50 can include a zinc stannate layer as described above and at least on other layer, such as a zinc oxide layer over and/or under the zinc stannate layer. The zinc oxide layer(s) can have a thickness in the range of 10 Å to 600 Å, e.g. 20 Å to 500 Å, or 30 Å to 300 Å, or 50 Å to 300 Å, or 80 A to 300 Å, or 100 Å to 200 Å.

A second heat and/or radiation reflective layer 58 can be deposited over the second dielectric layer 50. The second reflective layer 58 can include any one or more of the reflective materials described above with respect to the first reflective layer 46. In one non-limiting embodiment, the second reflective layer 58 comprises silver having a thickness in the range of 25 Å to 30 Å, e.g., 30 Å to 300 Å, or 50 Å to 200 Å, or 70 Å to 200 Å, or 100 Å to 200 Å, or 90 Å to 170 Å, or 130 Å. Other materials that can be used as second reflective layer 58 can have similar thickness ranges.

A second primer film 60 can be deposited over the second reflective layer 58. The second primer film 60 can be any of the materials described above with respect to the first primer film 48. In one non-limiting embodiment, the second primer film includes titanium having a thickness in the range of 5 Å to 50 Å, e.g., 10 Å to 25 Å, or 15 Å to 25 Å, or 20 Å. Other materials that can be used as second primer film 60 can have similar thickness ranges.

A third dielectric layer 62 can be deposited over the second reflective layer 58 (e.g., over the second primer film 60). The third dielectric layer 62 can also include one or more metal oxide or metal alloy oxide-containing layers, such as discussed above with respect to the first and second dielectric layers 40, 50. In one non-limiting embodiment, the third dielectric layer 62 comprises at least one high refractive index material, e.g., a metal alloy oxide-containing layer, e.g., a zinc stannate layer (Zn₂SnO₄), and has a thickness in the range of 100 Å to 1500 Å, e.g., 200 Å to 1500 Å, or 400 Å to 1500 Å, or 500 Å to 1500 Å, or 600 Å to 1000 Å, or 100 Å to 800 Å, or 200 Å to 700 Å, or 300 Å to 600 Å, or 550 Å to 600 Å. In another non-limiting embodiment, the third dielectric layer 62 can be a multi-layer structure. For example, the third dielectric layer 62 can include a zinc stannate layer as described above and at least on other layer, such as a zinc oxide layer over and/or under the zinc stannate layer. The zinc oxide layer(s) can have a thickness in the range of 10 Å to 600 Å, e.g. 20 Å to 500 Å, or 30 Å to 300 Å, or 50 Å to 300 Å, or 80 Å to 300 Å, or 100 Å to 200 Å.

Thus, the coating 34a could be described generally as H¹/M¹/H²/M²/H³, where H¹, H² and H³ represent layers comprising at least one high refractive index material and M¹ and M² represent metallic layers. As will be understood, H¹, H² and H³ can be the same or different layers and M¹ and M² can be the same or different layers.

The coating 34b shown in FIG. 3 is similar to that of FIG. 2 but further includes a third heat and/or radiation reflective layer 70 deposited over the third dielectric layer 62. The third reflective layer 70 can be of any of the materials discussed above with respect to the first and second reflective layers. In one non-limiting embodiment, the third reflective layer 70 includes silver and has a thickness in the range of 25 Å to 300 Å, e.g., 30 Å to 300 Å, or 50 Å to 300 Å, or 50 Å to 200 Å, or 70 Å to 200 Å, or 100 Å to 200 Å, or 90 Å to 170 Å, or 120 Å. Other materials that can be used as third reflective layer 70 can have similar thickness ranges.

A third primer film 72 can be deposited over the third reflective layer 70. The third primer film 72 can be of any of the primer materials described above with respect to the first or second primer films. In one non-limiting embodiment, the third primer film is titanium and has a thickness in the range of 5 Å to 50 Å, e.g., 10 Å to 25 Å, or 20 Å. Other materials that can be used as third primer film 72 can have similar thickness ranges.

A fourth dielectric layer 74 can be deposited over the third reflective layer (e.g., over the third primer film 72). The fourth dielectric layer 74 can be comprised of one or more metal oxide or metal alloy oxide-containing layers, such as those discussed above with respect to the first, second, or third dielectric layers 40, 50, 62. In one non-limiting embodiment, the fourth dielectric layer 74 comprises at least one high refractive index material, e.g., a metal alloy oxide layer, e.g., a zinc stannate layer (Zn₂SnO₄). The zinc stannate layer can have a thickness in the range of 50 Å to 600 Å, e.g., 100 Å to 600 Å, or 150 Å to 500 Å, or 200 Å to 500 Å, or 300 Å to 500 Å, or 400 Å to 500 Å. Other materials that can be used as fourth dielectric layer 74 can have similar thickness ranges.

Thus, coating 34b could be represented generally as H¹/M¹/H²/M²/H³/M³/H⁴, where H¹, H², H³ and H⁴ represent layers comprising at least one high refractive index material and M¹, M² and M³ represent metallic layers. As will be appreciated, H¹, H², H³ and H⁴ can be the same or different and M¹, M² and M³ can be the same or different.

The coating 34c shown in FIG. 4 is also similar to that of FIG. 2 but includes a low refractive index layer 76 deposited over the third dielectric layer 62. In one non-limiting embodiment, the low refractive index layer 76 comprises silica and/or alumina and has a thickness in the range of 100 Å to 800 Å, e.g., 200 Å to 800 Å, or 200 Å to 600 Å. Other materials that can be used as layer 76 can have similar thickness ranges. A fourth high refractive index layer 78 is formed over the low refractive index layer 76. In one non-limiting embodiment, the fourth high refractive index layer 78 comprises zinc stannate and has a thickness in the range of 100 Å to 800 Å, e.g. 100 Å to 700 Å, or 200 Å to 700 Å. Other materials that can be used as layer 78 can have similar thickness ranges.

Thus, coating 34c could be represented generally as H¹/M¹/H²/M²/H³/L¹/H⁴, wherein H¹, H², H³ and H⁴ represent layers comprising at least one high refractive index material (which can be the same or different); L¹ represents a layer comprising at least one low refractive index material; and M¹ and M² represent metal layers and can be the same or different.

As shown in FIG. 1, a protective overcoat 80 can be deposited over the outermost dielectric layer of the aesthetic coating 30 to assist in protecting the underlying layers, such as the antireflective layers, from mechanical and chemical attack during processing. The protective coating 80 can be an oxygen barrier coating layer to prevent or reduce the passage of ambient oxygen into the underlying layers of the aesthetic coating 30, such as during heating or bending. The protective coating 80 can be of any desired material or mixture of materials. In one non-limiting exemplary embodiment, the protective coating 80 can include a layer having one or more metal oxide materials, such as but not limited to oxides of aluminum, silicon, or mixtures thereof. For example, the protective coating 80 can be a single coating layer comprising in the range of 0 wt. % to 100 wt. % alumina and/or 100 wt. % to 0 wt. % silica, or 5 wt. % to 95 wt. % alumina and 95 wt. % to 5 wt. % silica, or 10 wt. % to 90 wt. % alumina and 90 wt. % to 10 wt. % silica, or 15 wt. % to 90 wt. % alumina and 85 wt. % to 10 wt. % silica, or 50 wt. % to 75 wt. % alumina and 50 wt. % to 25 wt. % silica, or 50 wt. % to 70 wt. % alumina and 50 wt. % to 30 wt. % silica, or wt. % to 100 wt. % alumina and 65 wt. % to 0 wt. % silica, or 70 wt. % to 90 wt. % alumina and 30 wt. % to 10 wt. % silica, or 75 wt. % to 85 wt. % alumina and 25 wt. % to 15 wt. % of silica, or 88 wt. % alumina and 12 wt. % silica, or 65 wt. % to 75 wt. % alumina and 35 wt. % to 25 wt. % silica, or 70 wt. % alumina and 30 wt. % silica, or 60 wt. % to less than 75 wt. % alumina and greater than 25 wt. % to 40 wt. % silica. Other materials, such as aluminum, chromium, hafnium, yttrium, nickel, boron, phosphorous, titanium, zirconium, and/or oxides thereof, can also be present, such as to adjust the refractive index of the protective coating 80. In one non-limiting embodiment, the refractive index of the protective coating 80 can be in the range of 1 to 3, such as 1 to 2, such as 1.4 to 2, such as 1.4 to 1.8.

In one non-limiting embodiment, the protective coating 80 is a combination silica and alumina coating. The protective coating 80 can be sputtered from two cathodes (e.g., one silicon and one aluminum) or from a single cathode containing both silicon and aluminum. This silicon/aluminum oxide protective coating 80 can be written as SiₓAl₁₋ₓO_{1.5+x/2}, where x can vary from greater than 0 to less than 1.

Alternatively, the protective coating 80 can be a multi-layer coating formed by separately formed layers of metal oxide materials, such as but not limited to a bi-layer formed by one metal oxide-containing layer (e.g., a silica and/or alumina-containing first layer) formed over another metal oxide-containing layer (e.g., a silica and/or alumina-containing second layer). The individual layers of the multi-layer protective coating can be of any desired thickness.

The protective coating 80 can be of any desired thickness. In one non-limiting embodiment, the protective coating 80 is a silicon/aluminum oxide coating (SiₓAl₁₋ₓO_{1.5+x/2}) having a thickness in the range of 50 Å to 50,000 Å, e.g. 50 Å to 10,000 Å, or 100 Å to 1,000 Å, or 100 Å to 500 Å, or 100 Å to 400 Å, or 200 Å to 300 Å, or 250 Å. Further, the protective coating 80 can be of non-uniform thickness. By “non-uniform thickness” is meant that the thickness of the protective coating 80 can vary over a given unit area, e.g., the protective coating 80 can have high and low spots or areas.

In another non-limiting embodiment, the protective coating 80 can comprise a first layer and a second layer formed over the first layer. In one specific non-limiting embodiment, the first layer can comprise alumina or a mixture or alloy comprising alumina and silica. For example, the first layer can comprise a silica/alumina mixture having at least 5 wt. % alumina, e.g., at least 10 wt. % alumina, or at least 15 wt. % alumina, or at least 30 wt. % alumina, or at least 40 wt. % alumina, or 50 wt. % to 70 wt. % alumina, or 70 wt. % to 100 wt. % alumina and 30 wt. % to 0 wt. % silica, or 90 wt. % to 100 wt. % alumina and 10 wt. % to 0 wt. % silica. In one non-limiting embodiment, the first layer can have a thickness in the range of greater than 0 Å to 1 micron, e.g., 50 Å to 100 Å, or 100 Å to 250 Å, or 101 Å to 250 Å, or 100 Å to 150 Å, or greater than 100 Å to 125 Å. The second layer can comprise silica or a mixture or alloy comprising silica and alumina. For example, the second layer can comprise a silica/alumina mixture having at least 40 wt. % silica, e.g., at least 50 wt. % silica, or at least 60 wt. % silica, or at least 70 wt. % silica, or at least 80 wt. % silica, or 80 wt. % to 90 wt. % silica and 10 wt. % to 20 wt. % alumina, or 85 wt. % silica and 15 wt. % alumina. In one non-limiting embodiment, the second layer can have a thickness in the range of greater than 0 Å to 2 microns, e.g., 50 Å to 5,000 Å, or 50 Å to 2,000 Å, or 100 Å to 1,000 Å, or 300 Å to 500 Å, or 350 Å to 400 Å. Non-limiting examples of suitable protective coatings are described, for example, in U.S. patent application Ser. Nos. 10/007,382; 10/133,805; 10/397,001; 10/422,094; 10/422,095; and 10/422,096.

The transparency 10 can further include reflection coating 32, for example on the No. 4 surface 22 of the second ply 18. In one non-limiting embodiment, the reflection coating 32 is an antireflective coating comprising alternating layers of relatively high and low index of refraction materials. As described above, a “high” index of refraction material can be any material having a higher index of refraction than that of the “low” index material. In one non-limiting embodiment, the low index of refraction material is a material having an index of refraction of less than or equal to 1.75. The antireflective coating 32 can be, for example but not limiting to the present invention, a multi-layer coating as shown in FIG. 5 having a first metal alloy oxide layer 86 (first layer) having a refractive index less than or equal to 1.75, a second metal oxide layer 88 (second layer) deposited over the first layer and having a refractive index greater than 1.75, a third metal alloy oxide layer 90 (third layer) deposited over the second layer and having a refractive index less than or equal to 1.75, and a metal oxide top layer 92 (fourth layer) deposited over the third layer and having a refractive index greater than 1.75. Alternatively, the antireflective coating 32 can be, for example but not limiting to the present invention, a multi-layer coating as shown in FIG. 5 having a first metal alloy oxide layer 86 (first layer) having a refractive index greater than 1.75, a second metal oxide layer 88 (second layer) deposited over the first layer and having a refractive index less than or equal to 1.75, a third metal alloy oxide layer 90 (third layer) deposited over the second layer and having a refractive index greater than 1.75, and a metal oxide top layer 92 (fourth layer) deposited over the third layer and having a refractive index less than or equal to 1.75. In one non-limiting embodiment, the fourth layer 92 (the upper low index layer) comprises silica or alumina or a mixture or combination thereof, the third layer 90 (the upper high index layer) comprises zinc stannate or zirconia or mixtures or combinations thereof, the second layer 88 (the bottom low index layer) comprises silica or alumina or a mixture or combination thereof, and the first layer 86 (the bottom high index layer) comprises zinc stannate or zirconia or mixtures or combinations thereof.

As will be appreciated by one skilled in the art, the thickness of a coating layer can be specified in different ways. For example, the actual physical thickness of the layer can be specified. Alternatively, the optical thickness of the layer can be specified. As is common in the art and as used herein, the “optical thickness” of a material is defined as the thickness of the material divided by the refractive index of the material. Thus, 1 quarter wave optical thickness (QWOT) of a material having a refractive index of 2 with respect to a reference wavelength of 550 nm would be 0.25×(550 nm÷2), which equals 68.75 nm. As another example, 0.33 QWOT of a material having a refractive index of 1.75 with respect to a reference wavelength of 550 nm would be equivalent to 0.33×[0.25×(550 nm÷1.75)] or 25.93 nm. Conversely, a material with an index of refraction of 2.2 and a thickness of 50 nm would be equivalent to [(50 nm÷550 nm)×2.2]+0.25 or 0.8 QWOT based on a wavelength of 550 nm. As will be appreciated, although the quarter wave optical thickness of two materials may be the same, the actual physical thickness of the layers may be different due to the differing refractive indices of the materials. As used herein and in the following Example, the QWOT values are those defined with respect to a reference wavelength of 550 nm.

In one non-limiting embodiment, the top layer 92 comprises a material, for example silica, and has a thickness ranging from 0.7 to 1.5 quarter wave (QWOT), e.g., 0.71 to 1.45 quarter wave, or 0.8 to 1.3 quarter wave, or 0.9 to 1.1 quarter wave. As described above, by “quarter wave” is meant: [(physical layer thickness)·4·(refractive index)]/(reference wavelength of light). In this discussion, the reference wavelength of light is 550 nm. In this non-limiting embodiment, the thickness of the upper high index layer 90 is defined by the formula: [−0.3987·(quarter wave value of top layer)²]-[1.1576·(quarter wave value of top layer)]+2.7462. Thus, if the top layer 92 is 0.96 quarter wave, the upper high index layer 90 would be [−0.3987·(0.96)²]−[1.1576·(0.96)]+2.7462=1.2675 quarter wave. The bottom low index layer 88 is defined by the formula: [2.0567·(quarter wave value of top layer)²]-[3.5663·(quarter wave value of top layer)]+1.8467. The bottom high index layer 86 is defined by the formula: [−2.1643·(quarter wave value of top layer)²]+[4.6684·(quarter wave value of top layer)]-2.2187. In one specific non-limiting embodiment, the antireflective coating 32 comprises a top layer 92 of silica of 0.96 quarter wave (88.83 nm), a layer 90 of zinc stannate of 1.2675 quarter wave (84.72 nm), a layer 88 of silica of 0.3184 quarter wave (29.46 nm), and a layer 86 of zinc stannate of 0.2683 quarter wave (17.94 nm). In other non-limiting embodiments, the quarter wave values of the layers 86, 88, and 90 can vary by ±25% from the formula values above, such as ±10%, such as ±5%.

Other suitable antireflective coatings are disclosed in U.S. Pat. No. 6,265,076 at column 2, line 53 to column 3, line 38; and Examples 1-3, and in U.S. Pat. No. 6,570,709 at column 2, line 64 to column 5, line 22; column 8, lines 12-30; column 10, line 65 to column 11, line 11; column 13, line 7 to column 14, line 46; column 16, lines 35-48; column 19, line 62 to column 21, line 4; Examples 1-13; and Tables 1-8.

In one practice of the invention, the decorative band 26 is a ceramic enamel material having a color that enhances or accentuates the color of the transparency 10. As will be appreciated by one skilled in the automotive art, conventional shade bands are typically black. However, in the practice of the invention, the decorative band 26 can be of any desired color to complement the color of the transparency 10. The material used to make the decorative band 26 can comprise an oil, a frit (such as a borosilicate frit), and a pigment of a desired color The material can be placed on a surface of one of the plies and heated to melt and bond the material to the ply to form the decorative band 26. Exemplary colors for the decorative band 26 include, but are not limited to white, yellow, blue, red, brown, gold, silver, and green, just to name a few. Additionally, designs or other decorative symbols, such as but not limited to corporate logos, names of sports teams, individual names, or decorative designs could be formed in the decorative band 26.

Illustrating the invention are the following non-limiting Examples.

### EXAMPLE 1

Laminated articles were prepared having the structure listed in Table I. The glass was STARPHIRE® glass, which is commercially available from PPG Industries, Inc. of Pittsburgh, Pa. The coating layers were applied by conventional MSVD techniques. Referring to Table I, it should be understood that the Si₈₅Al₁₅Oₓ coating represents the composition of the cathode from which this coating was sputtered. More specifically, Si₈₅Al₁₅Oₓ means that a cathode comprised of 85 wt. % Si and 15 wt. % Al was sputtered in an oxygen atmosphere to form the silicon and aluminum oxide coating. The ZnO coating was sputtered from a zinc cathode having 10 wt. % Sn to improve the sputtering characteristics. All the TiO₂ layers were sputtered from a Ti cathode and deposited as Ti metal layers, which were subsequently oxidized during heating to bend the glass to form a windshield.

TABLE I

| Material | Thickness | |
|---|---|---|
| Glass | 2.3 | mm |
| PVB | 0.75 | mm |
| Si₈₅Al₁₅Oₓ | 1000 | Å |
| Zn₂SnO₄ | 400 | Å |
| ZnO | 80 | Å |
| TiO₂ | 20 | Å |
| Ag | 133 | Å |
| ZnO | 80 | Å |
| Zn₂SnO₄ | 890 | Å |
| ZnO | 80 | Å |
| TiO₂ | 13 | Å |
| Ag | 105 | Å |
| ZnO | 80 | Å |
| Zn₂SnO₄ | 440 | Å |
| Glass | 2.3 | mm |

Six articles were prepared and the color characteristics were measured. The results for the six articles are listed in Table II below.

TABLE II

| Parameter | Value range |
|---|---|
| L* | 51 to 54 |
| a* | −5.1 to 7.6 |
| b* | −31 to −33.1 |

The articles had an aesthetically pleasing blue color.

### EXAMPLE 2

In this example, a computer-generated laminated article was designed using WINFILM software commercially available from FTG Software Associates of Princeton, N.J.

The article has the structure set forth in Table III.

TABLE III

| Material | Thickness | |
|---|---|---|
| Si₈₅Al₁₅Oₓ | 580 | Å |
| ZnSnO₄ | 930 | Å |
| Glass | 2.3 | mm |
| PVB | 0.75 | mm |
| Si₈₅Al₁₅Oₓ | 550 | Å |
| Zn₂SnO₄ | 131.6 | Å |
| TiO₂ | 20 | Å |
| Ag | 90 | Å |
| ZnSnO₄ | 473 | Å |
| TiO₂ | 20 | Å |
| Ag | 80 | Å |
| ZnSnO₄ | 291 | Å |
| Si₈₅Al₁₅Oₓ | 560.8 | Å |
| Zn₂SnO₄ | 434.3 | Å |
| Glass | 2.3 | mm |

The computer-generated article had color characteristics as set forth in Table IV as determined by the WINFILM software.

TABLE IV

| Parameter | Value range |
|---|---|
| L* | 45 |
| a* | 35 |
| b* | −7 |

The article had an aesthetically pleasing red color.

### EXAMPLE 3

Laminated articles were prepared having the structure listed in Table V. The glass was 2.1 mm CLEAR glass, which is commercially available from PPG Industries, Inc. of Pittsburgh, Pa. The coating layers were applied by conventional MSVD techniques. The ZnO coating was sputtered from a zinc cathode having 10 wt. % Sn to improve the sputtering characteristics. All the TiO₂ layers were sputtered from a Ti cathode and deposited as Ti metal layers, which were subsequently oxidized during heating to bend the glass to form a windshield.

TABLE V

| Material | Thickness | |
|---|---|---|
| Glass | 2.1 | mm |
| PVB | 0.75 | mm |
| TiO₂ | 35 | Å |
| Zn₂SnO₄ | 281 | Å |
| ZnO(10% wt. Sn) | 127 | Å |
| TiO₂ | 20 | Å |
| Ag | 134 | Å |
| Zn₂SnO₄ | 843 | Å |
| ZnO(10% wt. Sn) | 152 | Å |
| TiO₂ | 21 | Å |
| Ag | 112 | Å |
| ZnO(10% wt. Sn) | 156 | Å |
| Zn₂SnO₄ | 363 | Å |
| Glass | 2.1 | mm |

Six articles were prepared and the color characteristics were measured. The results for the six articles are listed in Table VI below.

TABLE VI

| Parameter | Value range |
|---|---|
| L* | 51 to 54 |
| a* | −5.1 to 7.6 |
| b* | −31 to −33.7 |

The articles had an aesthetically pleasing blue color.

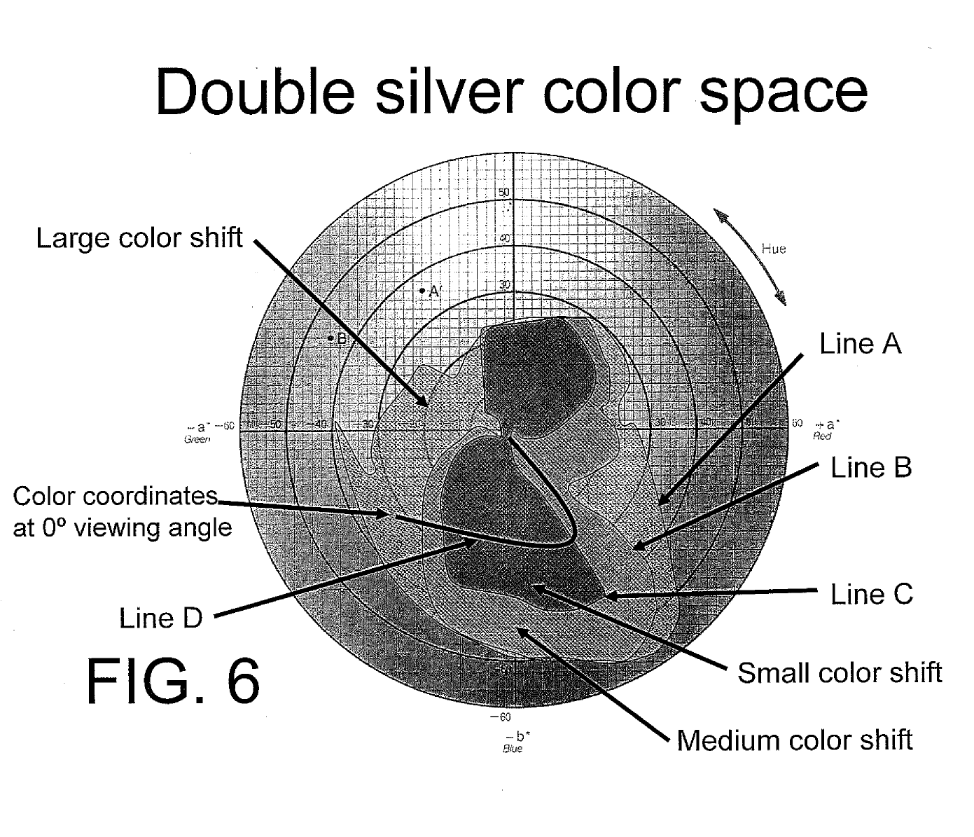

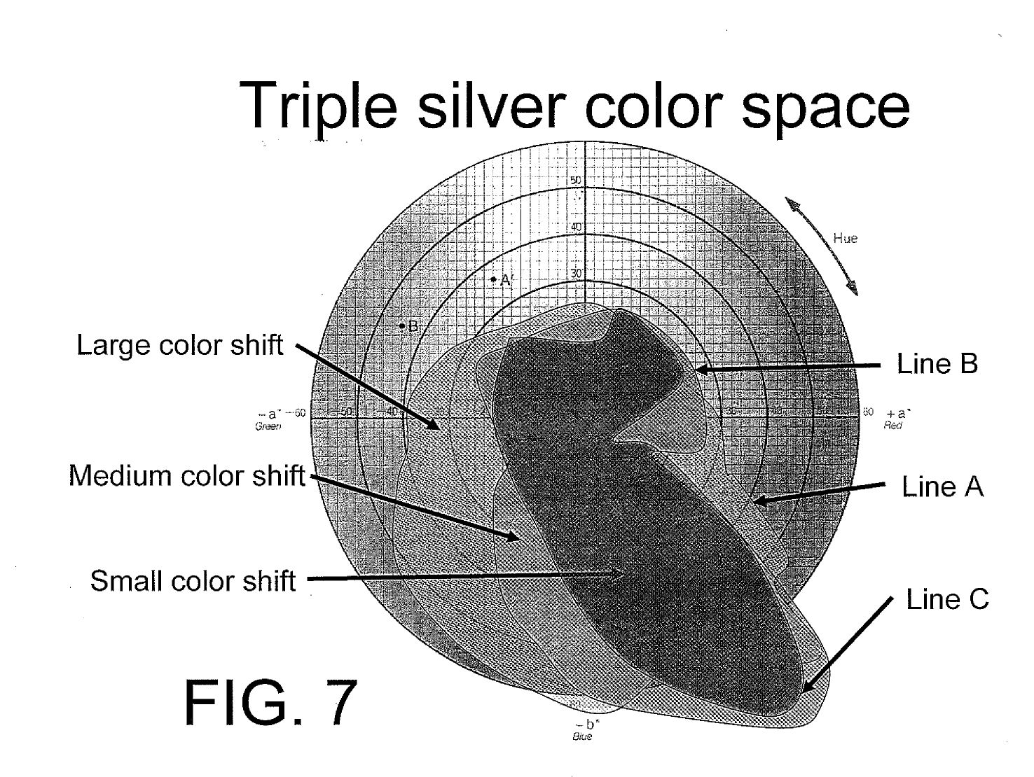

FIGS. 6 and 7 illustrate the color space achievable for an aesthetic coating 30 of the present invention. In particular, the area within Line A of FIG. 6 represents the color space achievable for an aesthetic coating 30 of the present invention that incorporates two silver reflective layers and the area within Line A of FIG. 7 represents the color space achievable for an aesthetic coating 30 of the present invention that incorporates three silver reflective layers. FIGS. 6 and 7 also illustrate the change in the reflected color, i.e., the color shift, of the coatings of the present invention as the viewing angle changes. More specifically, the color coordinates shown in FIGS. 6 and 7 are based on a viewing angle normal, i.e., perpendicular, to the coating surface. As used herein, a normal viewing angle is designated as a 0° viewing angle. As the viewing angle of the coating changes, the chroma (C*) and/or hue angle (H°) will change, and as the viewing angle approaches 90°, C* will approach 0, as discussed below in further detail. The coatings falling between Lines A and B in FIGS. 6 and 7 will show the greatest color shift, and in particular a color shift characterized by a change in H° of greater than 30° (large color shift). The coatings falling between Lines B and C will show less of a color shift and are characterized by a change in H° ranging from 15° to 30° (medium color shift). The coatings falling within Line C will show the least amount of color shift and are characterized by a change in H° of less than 15° (small color shift). With continued reference to FIG. 6, Line D represents the change in the color coordinates of one non-limiting double silver coating of the present invention as the viewing angle increase from 0° and approaches 90°. More specifically, for this particular coating, it can be seen that the coating has a blue-green color and a C* of about 32 at a 0° viewing angle. As the viewing angle changes, both the chroma and hue angle change. More specifically, coating color changes to a purple-red color (the hue angle changes by more than 30°) and C* approaches 0 as the viewing angle increases.

### EXAMPLE 4

In this example, a computer-generated laminated article was designed using WINFILM software commercially available from FTG Software Associates of Princeton, N.J.

The article has the structure set forth in Table VII.

TABLE VII

| Material | Thickness | |
|---|---|---|
| Glass | 2.1 | mm |
| PVB | 0.75 | mm |
| Top Oxide | See Table VIII | |
| TiO₂ | 13 | Å |
| Top Ag | See Table VIII | |
| Center Oxide | See Table VIII | |
| TiO₂ | 13 | Å |
| Bottom Ag | See Table VIII | |
| Bottom Oxide | See Table VIII | |
| Glass | 2.1 | mm |

The computer-generated article had color characteristics as set forth in Table VIII as determined by the WINFILM software. The values listed in Table VIII for the oxides are in QWOT and the values for the silver layers are in units of nanometers.

TABLE VIII

| top oxide | top silver | center oxide | bottom silver | bottom oxide | H° | C* |
|---|---|---|---|---|---|---|
| 1.47803405 | 7.3010605 | 1.45469155 | 10.0393406 | 0.449228424 | −172.31163 | 22.83959 |
| 0.42894311 | 11.6696038 | 1.39721165 | 7.15281918 | 1.638595781 | −157.43957 | 25.00694 |
| 1.05994611 | 9.07784624 | 1.54035006 | 7.2 | 1.605890288 | −142.37952 | 31.87471 |
| 0.86221636 | 11.2781957 | 1.53174193 | 7.70131957 | 1.540585939 | −127.41194 | 31.76128 |
| 0.60170621 | 12.1828347 | 1.52150696 | 10.1238893 | 1.1921954 | −112.2562 | 31.2927 |
| 0.76662165 | 15.2552864 | 1.50746268 | 11.5033085 | 0.832109277 | −97.496836 | 34.16264 |
| 0.85154085 | 15.8474899 | 1.44771742 | 9.31801635 | 0.827105069 | −82.524191 | 33.02236 |
| 1.00681752 | 14.7034473 | 1.3849677 | 7.28385626 | 0.993421761 | −67.620033 | 37.83522 |
| 0.96962323 | 14.4647907 | 1.29607388 | 7.49877319 | 0.991320057 | −53.85359 | 38.27008 |
| 1.10469792 | 7.49926791 | 1.14634744 | 9.27903996 | 1.658826436 | −38.007388 | 33.59996 |
| 1.10758961 | 7.49790471 | 1.12520224 | 9.86205429 | 1.917205213 | −22.710844 | 26.31427 |
| 0.91478606 | 7.49749251 | 1.20037453 | 14.7366175 | 0.461404822 | −22.819872 | 24.10925 |
| 0.88542716 | 7.49565361 | 1.15341349 | 13.9987259 | 0.441673945 | −7.6680225 | 21.70998 |
| 0.84622418 | 7.49508375 | 1.11996693 | 13.5361031 | 0.441591017 | 7.4141969 | 20.22717 |
| 0.82156413 | 7.49488149 | 1.08275396 | 13.0439915 | 0.441550423 | 22.489675 | 19.76049 |
| 0.82962032 | 7.49478527 | 1.01566837 | 12.0480034 | 0.441389357 | 37.57715 | 20.61959 |
| 0.77256356 | 7.49468338 | 0.93531471 | 11.1335855 | 0.441367213 | 52.621502 | 20.7844 |
| 0.62337519 | 7.25092896 | 0.87462608 | 11.3117515 | 0.441335923 | 62.934711 | 20.19332 |
| 0.92324817 | 7.49916012 | 0.99928502 | 7.49861915 | 0.962219848 | 82.624968 | 18.33789 |
| 0.8548692 | 7.49583053 | 0.93287294 | 7.49488161 | 0.886488435 | 97.16284 | 16.97084 |
| 1.97133787 | 7.49984555 | 1.43271422 | 7.47935997 | 0.475872629 | 112.90986 | 21.60134 |
| 1.87024787 | 7.49143564 | 1.37901846 | 7.47044243 | 0.446790429 | 127.20813 | 22.32101 |
| 1.8838755 | 7.49077073 | 1.38012854 | 9.11905986 | 0.44679516 | 142.44026 | 22.78468 |
| 1.84446203 | 7.49405669 | 1.37420613 | 10.3472094 | 0.447664001 | 157.43855 | 24.38749 |
| 1.68507472 | 7.39322332 | 1.39606639 | 10.4505774 | 0.448256997 | 172.53919 | 23.80216 |

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the present disclosure and any and all equivalents thereof. The following statements describe various aspects of the invention and form part of the present disclosure. However, as will be appreciated, the invention is not limited to the following statements.

What is claimed is:

1. A laminated transparency, comprising:
a first ply having a No. 1 and a No. 2 surface;
a second ply having a No. 3 and a No. 4 surface;
an interlayer positioned between the first and second plies; and
an aesthetic coating deposited over at least a portion of the first or second plies,
wherein the transparency has a color defined by:
at least one of |a*| and |b*| is greater than or equal to 10.

2. The transparency of statement 1, wherein the transparency has a color defined by:
L*≧44.

3. The transparency of statement 1, wherein the transparency has a color defined by:
40≦L*≦60;
10≦|a*|≧50; and
10≦|b*|≦80.

4. The transparency of statement 1, wherein the transparency has a color defined by:
40≦L*≦60; and
15≦C*≦90.

5. The transparency of statement 1, wherein the transparency has a color defined by:
40≦L*≦60;

|a*|≦10, and

|b*|≦10.

6. The transparency of statement 1, further including a reflection coating deposited over at least a portion of one of the plies.

7. The transparency of statement 1, wherein the aesthetic coating comprises a coating stack comprising:
H¹/M¹/H²/M²/H³,
where H¹, H² and H³ represent layers comprising at least one high refractive index material and M¹ and M² represent metallic layers.

8. The transparency of statement 1, wherein the aesthetic coating comprises a coating stack comprising:
H¹/M¹/H²/M²/H³/M³/H⁴,
where H¹, H², H³ and H⁴ represent layers comprising at least one high refractive index material and M¹, M² and M³ represent metallic layers.

9. The transparency of statement 1, wherein the aesthetic coating comprises a coating stack comprising:
H¹/M¹/H²/M²/H³/L¹/H⁴,
where H¹, H², H³ and H⁴ represent layers comprising at least one high refractive index material, M¹ and M² represent metallic layers, and L¹ represents a layer comprising at least one low refractive index material.

10. The transparency of statement 1, wherein the transparency has an Lta of at least 70%.

11. The transparency of statement 1, wherein the aesthetic coating is on the No. 2 surface.

12. The transparency of statement 6, wherein the reflection coating is an antireflective coating is on the No. 4 surface.

13. The transparency of statement 12, wherein the antireflective coating comprises a first layer having a refractive index greater than 1.75, a second layer deposited over the first layer and having a refractive index less than or equal to 1.75, a third layer deposited over the second layer and having a refractive index greater than 1.75, and a fourth layer deposited over the third layer and having a refractive index less than or equal to 1.75.

14. The transparency of statement 1, including a protective overcoat deposited over the aesthetic coating, the protective overcoat comprising at least one of silica, alumina, zirconia, and mixtures thereof.

15. The transparency of statement 7, wherein each of the metallic layers comprises a metal selected from gold, copper, silver, or mixtures, alloys, or combinations including at least one thereof.

16. The transparency of statement 7, wherein each of the high refractive index materials is selected from zirconia, titania, zinc oxide, zinc stannate, and mixtures or combinations thereof.

17. The transparency of statement 9, wherein each of the low refractive index materials is selected from silica, alumina, and mixtures or combinations thereof.

18. The transparency of statement 1, further comprising a decorative band located around at least a portion of a perimeter of at least one of the plies, the decorative band having a color selected to complement the color of the transparency.

19. The transparency of statement 18, wherein the decorative band includes at least one of decorative symbols and/or decorative designs.

20. A laminated transparency, comprising:
(a) a first glass ply having a No. 1 and a No. 2 surface;
(b) a second glass ply having a No. 3 and a No. 4 surface;
(c) an interlayer positioned between the first and second glass plies;
(d) an aesthetic coating deposited over at least a portion of the No. 2 surface, the aesthetic coating comprising a coating stack comprising:
H¹/M¹/H²/M²/H³,
where H¹, H² and H³ represent layers comprising at least one material having a refractive index greater than 1.75, and M¹ and M² represent metallic layers,
wherein the transparency has a color defined by:

|a*|≧10; and

|b*|≧10
(e) an antireflective layer formed over at least a portion of the No. 4 surface.

21. The transparency of statement 20, wherein the transparency has a color defined by:
L*≧40.

22. The transparency of statement 20, wherein H¹, H² and H³ are each selected from zirconia, titania, zinc stannate, and mixtures or combinations thereof.

23. The transparency of statement 20, wherein M¹ and M² are each selected from gold, silver, copper, or mixtures, alloys, or combinations including at least one thereof.

24. The transparency of statement 20, wherein the antireflective coating comprises a first layer having a refractive index greater than 1.75, a second layer deposited over the first layer and having a refractive index less than or equal to 1.75, a third layer deposited over the second layer and having a refractive index greater than 1.75, and a fourth layer deposited over the third layer and having a refractive index less than or equal to 1.75.

25. The transparency of statement 20, wherein the transparency has an Lta of at least 70%.

26. The transparency of statement 20, including a protective overcoat deposited over the aesthetic coating, the protective overcoat comprising at least one of silica, alumina, zirconia, and mixtures thereof.

27. The transparency of statement 20, further comprising a decorative band located around at least a portion of a perimeter of at least one of the plies, the decorative band having a color selected to complement the color of the transparency.

28. The transparency of statement 27, wherein the decorative band includes at least one of decorative symbols and/or decorative designs.

29. A laminated vehicle transparency, comprising:
(a) a first glass ply having a No. 1 and No. 2 surface;
(b) a second glass ply having a No. 2 and a No. 3 surface;
(c) a polymeric interlayer positioned between the first and second glass plies;
(d) an aesthetic coating deposited over at least a portion of the No. 2 surface, the aesthetic coating comprising a coating stack comprising:
H¹/M¹/H²/M²/H³,
where H¹, H² and H³ each comprise zinc stannate, and M¹ and M² each comprise silver,
wherein the transparency has a color defined by:
L*≧40;

|a*|≧10; and

|b*|≧10
(e) a protective overcoat deposited over the aesthetic coating, the protective coating comprising a multi-layer coating stack comprising at least one of silica, alumina, zirconia, and mixtures or combinations thereof; and
(f) an antireflective coating formed over at least a portion of the No. 4 surface,
wherein the antireflective coating comprises a first layer having a refractive index greater than 1.75, a second layer deposited over the first layer and having a refractive index less than or equal to 1.75, a third layer deposited over the second layer and having a refractive index greater than 1.75, and a fourth layer deposited over the third layer and having a refractive index less than or equal to 1.75.

30. An aesthetic transparency comprising:
at least one substrate having a first major surface and a second major surface;
an aesthetic coating formed over at least a portion of the first major surface; and
a reflection coating formed over at least a portion of the second major surface,
wherein the transparency has a color defined by |a*|≧10 and |b*|≧10.

31. The transparency of statement 30, wherein the transparency has a color defined by:
L*≧40.

32. A laminated transparency, comprising:
a first ply;
a second ply;
an interlayer positioned between the first and second plies; and
an aesthetic coating positioned between the first and second plies,
wherein the transparency has a color defined by;
at least one of (a) |a*|≧10 and |b*|≧10 and (b) L*≧40.
